(19) United States
(12) Patent Application Publication
(10) Pub. No.: US 2012/0116786 A1
(43) Pub. Date: May 10, 2012

(54) Method and System for a lottery ticket identification owner of the ticket by a personal telephone number

(76) Inventor: Eyal Losato, Bear-Seeva (IL)

(21) Appl. No.: 12/941,248

(22) Filed: Nov. 8, 2010

(51) Int. Cl. G06Q 99/00; G06Q 90/00

(52) U.S. Cl. 705/1.1; 705/500

(57) ABSTRACT

This invention innovate a new invention, in method and system for a lottery ticket identification mark that enables the identification of the ticket owner, this by a personal telephone number of the ticket owner that is marked on the lottery ticket at the purchasing time.

Wherein, the present invention Method and System relating to a lottery ticket and a lottery ticket gaming system, in which the telephone number of the owner and user that purchases a lottery ticket is attached to the lottery ticket, in a numerical plain numbers of digits, or by a coded method, wherein, the system of the present invention enabling to communicates with the owner by messages to his telephone number, regarding announcement of his success in the gaming participations for example,

Wherein, purchasing a lottery ticket in such a method, and of such lottery ticket, can be preformed from a distance geographical locations by the participators, and yet, the system will enable and will have the ability to make the desirable identification signed of the owner telephone number on a specific lottery card

### FIELD OF THE INVENTION

The present invention directed to a lottery ticket, and to the lottery method and system, which enables a printed lottery ticket by the method and system of the present invention, including the identification data of each specific owner, by printing his personal telephone number on the ticket for example, and a system that enable a communicating abilities with the specific owner for purposes such as to delivering information and sending such information to each ticket owners telephone number regarding his ticket succeeding in the lottery for example.

### BACKGROUND OF THE INVENTION

Lottery tickets are well known and have been played by a significant number of players in most of the countries of the world. One type of lottery ticket enables the player to select a finite group of numbers from a universe of such numbers and wait to hear whether at least a minimum number of the select numbers chosen by him are selected randomly by the lottery, in which case the lottery ticket may be a winning ticket, and may have a money award for example.

There are more types of lottery tickets that are scratch-off type lottery tickets which have games printed on the lottery ticket itself. The play area comprising a plurality of play indicia is covered by a scratch-off layer and the player, in accordance with the rules of the game, removes all or a portion of the scratch-off layer covering the play area. If a minimum number of play indicia or a certain pattern of play indicia appear beneath the scratch-off layer, a prize may be won.

Wherein, those lottery gaming and tickets has been a growing trend to introduce lottery tickets in which the holder of the ticket is to be waiting to see if select numbers chosen by him are parallel to the one selected randomly by the lottery organization, or in connection with scratch-off lottery tickets, furthermore, those tickets has a value, and some time a worthwhile wealth to the holder of the winning ticket.

One realizes that it is better safe from an unfortunate mistakes, or even from frauds situations and activity, if each ticket will have an easy “identification sign” of its real owner, and even before the announcement declaring and reviling if a specific ticket is a winning one, or if not.

It would therefore be a significant advance in the art of lottery tickets to provide an additional method and system for a lottery ticket identification owner by a personal telephone number on the ticket, and information flow to the owner of the ticket optionally directly from an totally machinery operating with no human intervene.

### SUMMARY OF THE INVENTION

In view of the above, the major purpose of this present invention is to invent a signifying lottery tickets that is identifying the owner that porches the ticket, and providing an additional method and system for a lottery ticket identification owner by his personal telephone number, which is attached to the ticket in the purchasing event, and furthermore, enabling delivering of an information to the owner of the ticket, optionally directly from a totally machinery operating system with no human intervene.

The present invention is generally directed to a lottery ticket and to a lottery system which combines on each lottery ticket the numbers and digits of a telephone number, or those numbers in coded methods, wherein, the numbers are in a sufficient pattern and way that enables the system of the present invention to makes a telephone call to the owner of the telephone, or to send him a message and information, or data, to that telephone device chosen by the owner that participate in purchasing of the lottery tickets, and chose to deliver this telephone number as his distinctiveness identifications on the lottery ticket.

Wherein, purchasing a lottery ticket in such a method, and of such lottery ticket, can be preformed from a distance geographical locations by the participators, and yet, the system will be able and will have the ability to make the desirable identification signed of the owner and user of a specific telephone number on a specific lottery card

### DESCRIPTION OF THE PREFERRED EMBODIMENTS

The present invention is generally directed to a lottery ticket, and to the lottery method and system, which enables a printed lottery ticket by the method and system of the present invention, including the identification data of each specific owner, by printing his personal telephone number on the ticket for example, and a system that enable a communicating abilities with the specific owner for purposes such as to delivering information and sending such information to each ticket owners telephone number regarding his ticket succeeding in the lottery for example.

The lottery ticket method and system, enabling to attaché the personal telephone number of the owner of the lottery ticket for the purpose of attribute and identifying the lottery ticket to the person that purchase the ticket, and for the purpose of communicating with this person, wherein the method enabled by the system of the present invention, wherein the system comprising:

a) a lottery ticket produced, or been memorized by the system, wherein, attached to the ticket, the numbers and digits of the a telephone number of the owner of the lottery ticket, or those numbers in coded methods, and

b) wherein, the numbers are in a sufficient pattern and way that enables the system of the present invention to makes a telephone call to the owner of the telephone, or to send him a message and information, or data, and

c) means enabling the system to communicate with a person of the lottery ticket, wherein the communication system enabling the person of the lottery ticket to obtain information and to perform a function regarding the participation in a lottery game.

The lottery ticket method and system further comprising means that enabling the system to send to the owner of the ticket via his telephone number, information by an automatic system.

The lottery ticket method and system further comprising means that enable the producing of the lottery ticket comprising means that enables the producing of the ticket with the purchaser of the ticket telephone number, by numerical digits, or by a coded pattern that enables the system to translate the coded pattern to the telephone numbers of the purchaser.

The lottery ticket method and system further comprising means that produce the lottery ticket comprising means that enables the purchaser of the ticket to add to the ticket a telephone number, by numerical digits, or by a coded pattern, wherein, the system have means that enables the system to translate the coded pattern, or the numbers, to the telephone numbers of the purchaser, and, to memorize the information of the telephone number, and optionally to enable by the system, or by another system, a delivery of information regarding the participant purchaser of the ticket.

The lottery ticket method and system further comprising means that enables the purchaser of the ticket to marks the ticket with another personal identification means, such as, his I.D. number, or his social security number, wherein, the system of the present invention by pass through an information data center or base, collecting the communication options available regarding the ticket purchaser communicational options, by the communication options that the data base of the information center suggest about him, such as by a telephone call, or email address or by postal address, wherein, passing information to each of those communication options could be preformed automatically by the system.

1. A lottery ticket method enabling to attaché the personal telephone number of the owner of the lottery ticket for the purpose of attribute and identifying the lottery ticket to the person that purchase the ticket, and for the purpose of communicating with this person, wherein the method enabled by the system of the present invention, wherein the system comprising:
a) a lottery ticket produced, or been memorized by the system, wherein, attached to the ticket, the numbers and digits of the a telephone number of the owner of the lottery ticket, or those numbers in coded methods, and
b) wherein, the numbers are in a sufficient pattern and way that enables the system of the present invention to makes a telephone call to the owner of the telephone, or to send him a message and information, or data, and
c) means enabling the system to communicate with a person of the lottery ticket, wherein the communication system enabling the person of the lottery ticket to obtain information and to perform a function regarding the participation in a lottery game.

2. The lottery ticket method of claim 1 wherein the system further comprising means that enabling the system to send to the owner of the ticket via his telephone number, information by an automatic system.

3. The lottery ticket method of claim 1 wherein the system that produce the lottery ticket comprising means that enables the producing of the ticket with the purchaser of the ticket telephone number, by numerical digits, or by a coded pattern that enables the system to translate the coded pattern to the telephone numbers of the purchaser.

4. The lottery ticket method of claim 1 wherein the system that produce the lottery ticket comprising means that enables the purchaser of the ticket to add to the ticket a telephone number, by numerical digits, or by a coded pattern, wherein, the system have means that enables the system to translate the coded pattern, or the numbers, to the telephone numbers of the purchaser, and, to memorize the information of the telephone number, and optionally to enable by the system, or by another system, a delivery of information regarding the participant purchaser of the ticket.

5. The lottery ticket method of claim 4 wherein the purchaser of the ticket to marks the ticket with another personal identification means, such as, his I.D. number, or his social security number, wherein, the system of the present invention by pass through an information data center or base, collecting the communication options available regarding the ticket purchaser communicational options, by the communication options that the data base of the information center suggest about him, such as by a telephone call, or email address or by postal address, wherein, passing information to each of those communication options could be preformed automatically by the system.
